(19) United States
(12) Patent Application Publication
(10) Pub. No.: US 2015/0251638 A1
(43) Pub. Date: Sep. 10, 2015

(54) Method and Device for Operating a Vehicle and Vehicle Having Such a Device

(71) Applicant: DAIMLER AG, Stuttgart (DE)

(72) Inventors: Ralf Bogenrieder, Stuttgart (DE); Carsten Brenk, Schemmerhofen (DE); Karl-Eugen Laubacher, Koengen (DE)

(73) Assignee: Daimler AG, Stuttgart (DE)

(21) Appl. No.: 14/429,226

(22) PCT Filed: Aug. 21, 2013
(86) PCT No.: PCT/EP2013/002519

§ 371 Date: Mar. 18, 2015

(30) Foreign Application Priority Data
Sep. 29, 2012 (DE) 10 2012 019 300.9

(51) Int. Cl. B60T 7/22; B60W 10/18; B60W 30/085; B60T 7/04

(52) U.S. Cl. CPC B60T 7/22; B60T 7/042; B60W 10/18; B60W 30/085; B60T 2201/024

(57) ABSTRACT

A method and a device control the brake of a vehicle when a rear-end collision is imminent. When an imminent rear-end collision is detected the vehicle is automatically braked. A potential collision time is determined and, depending on the potential collision time, a brake is activated before the occurrence of the same when the vehicle is at a standstill. The brake is automatically deactivated if no rear-end collision is detected at the potential collision time.

### BACKGROUND AND SUMMARY OF THE INVENTION

Exemplary embodiments of the invention relate to a method and device for the operation of a vehicle, wherein a rear-end collision that is imminent for the vehicle is detected and the vehicle is automatically braked. Exemplary embodiments of the invention also relate to a vehicle having such a device.

German patent document DE 10 2004 055 399 A1 discloses a method and a device for controlling a vehicle. In the case of a collision of the vehicle, the vehicle is braked by a brake of the vehicle being applied. Here, a collision is identified if a discharged airbag of the vehicle is detected and/or if a first threshold value for vehicle deceleration is exceeded. Once the vehicle has stopped after the braking, the brake remains applied until the vehicle ignition is switched off. Provision is furthermore made for the parking brake of the vehicle to be activated once the vehicle has stopped after the braking

Furthermore, German patent document DE 198 58 292 C2 discloses a safety system provided for the prevention of accident consequences in the case of a rear impact of the motor vehicle. Here, the distance and relative speed to a following vehicle are determined. Even before a calculated rear impact, an anticipated braking force is calculated and the correspondingly required brake pressure is established. After the rear impact, a comparison signal allocated to the positive vehicle longitudinal acceleration is determined, which is then compared to a threshold value. When the comparison signal exceeds the threshold value, a brake signal that continues the braking process is generated.

Exemplary embodiments of the invention are directed to an improved method compared to the prior art and an improved device for the operation of a vehicle, as well as such a vehicle.

A method for the operation of a vehicle provides that a rear-end collision that is imminent for the vehicle is detected and the vehicle is automatically braked when the rear-end collision is detected. According to the invention, a potential collision time is determined and, depending on the potential collision time, a brake is activated before the occurrence of the same when the vehicle is at a standstill, wherein the brake is automatically deactivated if no rear-end collision is detected at the potential collision time.

By means of the method according to the invention, validation with respect to the detected, imminent rear-end collision is carried out, such that a false activation of the brake, resulting from the detected, imminent rear-end collision, by means of which the vehicle is preferably firmly braked, is counteracted. If it is detected that the rear-end collision will not occur at the determined potential collision time, the brake is deactivated, such that the vehicle is no longer firmly braked and the driving operation thereof may be resumed. A firm braking duration of the vehicle is shortened in the case of a false activation of the brake with the application of the method according to the invention.

If the rear-end collision takes place, the brake is activated and the vehicle will come to a standstill, such that the risk of, for example, driverless, unbraked rolling of the vehicle is at least reduced. Thus, the risk of a subsequent collision of the vehicle and/or a crash of the vehicle can also be substantially reduced, provided that this is located on a bridge or close to a slope.

The activation of the brake preferably takes place for a predetermined duration during a rear-end collision such that the vehicle wheels are blocked and thus it can substantially be ruled out that the vehicle will drive into a vehicle located in front of it.

In an advantageous embodiment, an occurrence of the rear-end collision is detected with the aid of detected acceleration signals and/or with the aid of detected pressure signals and/or mechanically generated signals. In particular, the rear-end collision is detected by detectable signals caused by the rear-end collision itself. The brake is particularly advantageously activated directly after the detection of such a signal, since the rear-end collision that is imminent for the vehicle, which has already been detected, is validated by means of such a signal.

In a further advantageous embodiment of the method, the potential collision time is determined with the aid of a distance between the vehicle and a detected collision object and/or with the aid of a determined relative speed between these. Here, the potential collision time is particularly preferably determined by continuous determination of the distance and continuous determination of the relative speed, whereby it is possible to predict the potential collision time with comparable certainty.

Preferably, deactivation of the brake takes place when an accelerator pedal is applied. Here, the deactivation can particularly preferably take place both after the actually-occurring rear-end collision and in the case of a false activation of the brake. The driver himself also has the possibility of shortening the firm braking duration, wherein the deactivation of the brake after the rear-end collision occurring by applying the accelerator pedal can only be carried out after a predetermined further duration. Thus, the function of the firm braking can be ensured at least for the predetermined duration.

The invention moreover relates to a device for the operation of a vehicle, which has an environment detection device for the detection of a rear-end collision that is imminent for the vehicle and which is able to control a brake when the rear-end collision is detected, which brakes the vehicle. According to the invention, the environment detection device is coupled with a control unit for the determination of a potential collision time from first signals detected by means of the environment detection device, wherein the control unit is coupled with the brake and the brake can be controlled and activated depending on the potential collision time when the vehicle is at a standstill. To that end, the control unit is coupled with a collision detection device, by means of which an occurrence of the rear-end collision can be detected, wherein a control signal that can be supplied to the brake can be generated by means of the control unit, by means of which signal the brake can be deactivated if no rear-end collision occurs at the potential collision time.

It is possible, in a particularly advantageous manner, to deactivate the brake by means of the device if no rear-end collision occurs at the determined potential collision time. The firm braking duration of the vehicle can be shortened by the device, such that the vehicle can continue driving when the rear-end collision does not occur, without hindering the traffic behind it.

In an advantageous manner, the environment detection device has at least one radar-based detection unit arranged in the rear section of the vehicle, such that the environment of the rear section with respect to a potential collision object can be detected. In addition, with the aid of the detected signals of the detection unit arranged in the rear section, a distance of the vehicle relative to the potential collision object and a relative speed can be determined, such that the potential collision time is able to be predicted.

The collision detection device, by means of which the actual rear-end collision can be detected, has at least one pressure sensor and/or one acceleration sensor and/or one mechanically activatable sensor. It is possible, in a particularly advantageous manner, to determine the actual collision occurrence with detected signals of these sensors and to firmly brake the vehicle accordingly, for example in order to avoid a subsequent collision, such that the vehicle is fixed to the greatest possible extent when at a standstill.

The invention furthermore relates to a vehicle having such a device described above.

### BRIEF DESCRIPTION OF THE DRAWING FIGURE

Exemplary embodiments of the invention are illustrated in greater detail below by means of a drawing.

Here is shown:

FIG. 1 schematically, a vehicle with a block diagram of a device for the operation of the vehicle.

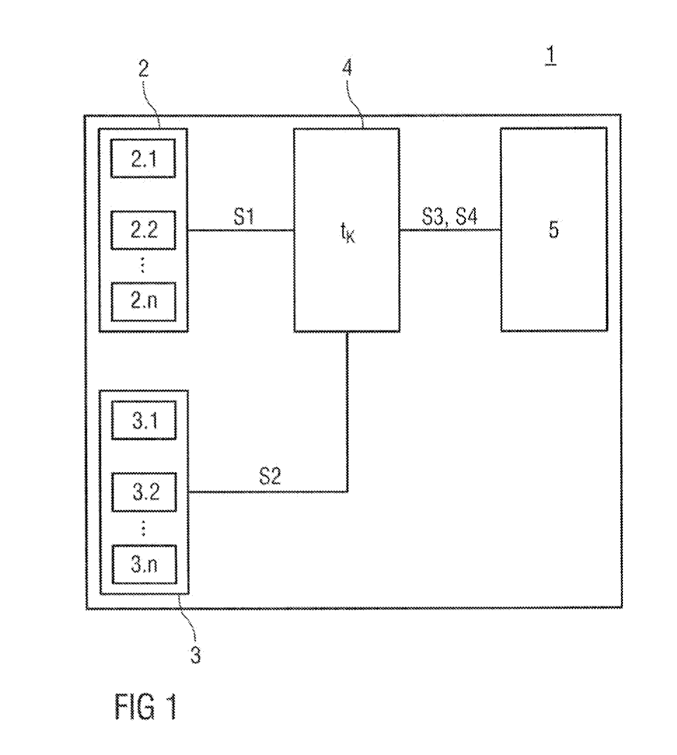

### DETAILED DESCRIPTION

In the single figure, a vehicle 1, in particular a passenger motor vehicle, is depicted with a device for the operation of the same.

The device has an environment detection device 2, a collision detection device 3, a control unit 4, and a controllable brake 5. Here, the brake 5 can be a service brake and/or a parking brake of the vehicle 1.

The environment detection device 2 comprises a number of detection units 2.1 to 2.n arranged in and/or on the vehicle, by means of which the environment of the vehicle 1 is able to be detected.

For example, the detection units 2.1 to 2.n function in a radar-based manner, wherein at least one of the detection units 2.1 to 2.n is arranged on and/or in the vehicle 1 in such a way that an environment of the rear section of the vehicle 1 is able to be detected. In particular, the detection of the environment serves to detect a potential collision object. The detection units 2.1 to 2.n of the environment detection device 2 are connected to the control unit 4, to which the first signals S1 are supplied for processing and analysis.

The device furthermore comprises the collision detection device 3, which is provided for the detection of a collision, in particular a rear-end collision. To that end, the collision detection device 3 has a number of sensor units 3.1 to 3.n, by means of which detected signals of the actual occurrence of the rear-end collision can be detected.

To that end, one of the sensor units 3.1 to 3.2 can be designed as a pressure sensor, by means of which a change in pressure resulting from the rear-end collision can be detected. These can alternatively or additionally be one or more sensor units 3.1 to 3.n, which are designed as an acceleration sensor or acceleration sensors and are arranged in an airbag control device that is not depicted in greater detail. An acceleration of the vehicle 1 resulting from the rear-end collision can be detected by means of such a sensor unit 3.1 to 3.2.

Furthermore, a mechanically activatable sensor unit 3.1 to 3.n can additionally or alternatively be provided for the detection of a rear-end collision, by means of which sensor unit, for example, a deformation of a vehicle part caused by the rear-end collision can be detected.

Second signals S2 detected by the sensor units 3.1 to 3.n of the collision detection device 3 are also supplied to the control unit 4, to which the collision detection unit is connected.

The control unit 4 is in turn connected to the brake 5 in the form of the service brake and/or parking brake of the vehicle 1.

The service brake, as part of the service brake system, serves to slow down the vehicle 1 when in driving operation, potentially to a standstill. The service brake is typically activated by a driver of the vehicle 1 via a brake pedal arranged in the interior of the vehicle.

In addition, the vehicle 1 possesses the parking brake, which, when in the activated state, blocks the vehicle wheels permanently. If the parking brake is activated, the vehicle 1 can be parked without the risk of it undesirably rolling away.

During the operation of the vehicle 1, which is located at the end of a traffic jam at a standstill, the environment of the rear section is detected by means of a detection unit 2.1 to 2.n of the environment detection device 2, said detection unit being arranged in the rear section of the vehicle 1. Here, a vehicle approaching the rear section of the vehicle 1, which is not depicted is greater detail, is detected. The approaching vehicle is detected as a potential collision object, in particular as a result of a predetermined distance to the vehicle 1 being fallen below. The signals detected by means of the detection unit 2.1 to 2.n are supplied to the control unit 4, which evaluates and processes the first signals S1. Thus, the current distance of both vehicles relative to each other and a relative speed are determined by means of the detected first signals S1.

The distance between the approaching vehicle and the vehicle 1 is continuously detected by means of the detection unit 2.1 to 2.n. If the distance decreases and if the rear-end collision of the vehicle 1 is unavoidable, a first control signal S3 is then generated by the control unit 4, the signal being supplied to the brake 5, preferably the parking brake, and automatically activating it. The vehicle wheels of the vehicle 1 that is at a standstill are blocked by the automatic activation of the parking brake as a brake 5.

The control unit 4 determines, with the aid of the detected first signals S1 of the environment detection device 2, a potential collision time t_{K}, so a point in time at which the collision will probably occur. At this point in time, the vehicle wheels are blocked by means of the activated brake 5 in the same way as before.

If the potential collision time t_{K} is reached and the sensor units 3.1 to 3.n of the collision detection device 3 have detected no signals that indicate an occurrence of the rear-end collision, the control unit 4 generates a second control signal S4.

The second control signal S4 is supplied to the activated brake 5, preferably the parking brake, whereby this is automatically deactivated and the vehicle wheels are no longer blocked, such that the vehicle 1 can resume its driving operation. Here, the brake 5 preferably remains activated for a predetermined duration, such that the vehicle 1 is firmly braked in the case of a false determination of the potential collision time t_{K}. After this predetermined duration has expired, the brake is deactivated.

If the rear-end collision occurs at the determined potential collision time t_{K}, the brake 5 in the form of the parking brake is activated, such that the vehicle 1 is at a standstill with blocked vehicle wheels. The occurrence of the rear-end collision is determined with the aid of detected acceleration signals and/or detected pressure signals and/or detected mechanically generated signals of the sensor units 3.1 to 3.n of the collision detection device 3. Due to the fact that the brake 5 is activated, the risk of an undesired rolling away of the vehicle 1, and thus a subsequent collision and/or a crash of the vehicle 1, for example with a bridge, can at least be reduced or ruled out to the greatest possible extent.

A firm braking time of the vehicle 1 can be reduced by means of the method in which the brake 5 is deactivated when the rear-end collision does not occur at the potential collision time t_{K} that is determined with the aid of the detected first signals S1.

Here, the non-occurrence of the rear-end collision can, for example, be based on an erroneous signal detection by the environment detection device 2, such that the brake 5 is activated without a potential collision object approaching the vehicle 1, in particular its rear section.

It is preferably possible to manually deactivate the automatically activated brake 5 after a predetermined period of time, wherein, for this, an accelerator pedal of the vehicle 1 is to be actuated.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-9. (canceled)

10. A method for operating a vehicle, the method comprising:
detecting, using a sensor, that a rear-end collision for the vehicle is imminent;
detecting that the vehicle is at a standstill;
determining a potential collision time for the detected imminent rear-end collision;
automatically activating a brake of the vehicle when the vehicle is at a standstill, the imminent rear-end collision is detected, and depending on the potential collision time; and
automatically deactivating the brake of the vehicle when no rear-end collision is detected at the potential collision time.

11. The method of claim 10, wherein when a rear-end collision occurs the activation of the brake is maintained for a predetermined duration.

12. The method of claim 10, wherein an occurrence of the rear-end collision is detected using detected acceleration signals, detected pressure signals, or mechanically generated signals.

13. The method of claim 10, wherein the potential collision time is determined based on a distance or relative speed between the vehicle and a detected collision object.

14. The method of claim 10, further comprising:
deactivating the brake when an accelerator pedal is actuated.

15. A vehicle system, comprising:
an environment detection device configured to at least detect a rear-end collision that is imminent for the vehicle, wherein a brake is activatable when an imminent rear-end collision is detected, said brake braking the vehicle;
a control unit coupled to the environment detection device and configured to determine a potential collision time from first signals detected by the environment detection device, wherein the control unit is coupled with the brake and the brake is controllable between an activated and inactivated state depending on the potential collision time before the occurrence of the potential collision and when the vehicle is at a standstill;
a collision detection device coupled to the control unit and configured to detect an occurrence of the rear-end collision,
wherein the control unit is configured to supply a second control signal to the brake to deactivate the brake no rear-end collision occurs at the potential collision time.

16. The vehicle system of claim 15, wherein the environment detection device has at least one radar-based detection unit arranged in a rear section of the vehicle.

17. The vehicle system of claim 15, wherein the collision detection device has at least one pressure sensor, at least one acceleration sensor, or at least one mechanically actuatable sensor.

18. A vehicle, comprising:
a brake configured to brake the vehicle;
an environment detection device configured to at least detect a rear-end collision that is imminent for the vehicle, wherein the brake is activatable when an imminent rear-end collision is detected;
a control unit coupled to the environment detection device and configured to determine a potential collision time from first signals detected by the environment detection device, wherein the control unit is coupled with the brake and the brake is controllable between an activated and inactivated state depending on the potential collision time before the occurrence of the potential collision and when the vehicle is at a standstill;
a collision detection device coupled to the control unit and configured to detect an occurrence of the rear-end collision,
wherein the control unit is configured to supply a second control signal to the brake to deactivate the brake no rear-end collision occurs at the potential collision time.
